(19) United States
(12) Patent Application Publication
(10) Pub. No.: US 2020/0371373 A1
(43) Pub. Date: Nov. 26, 2020

(54) FOCAL PLANE ASSEMBLY OF REMOTE SENSING SATELLITE AND IMAGE PROCESSING METHOD THEREOF

(71) Applicant: National Applied Research Laboratories, Taipei (TW)

(72) Inventors: Jer Ling, Hsinchu (TW); Ming-Yuan Yeh, Hsinchu (TW)

(73) Assignee: National Applied Research Laboratories, Taipei (TW)

(21) Appl. No.: 16/450,148

(22) Filed: Jun. 24, 2019

(30) Foreign Application Priority Data
May 22, 2019 (TW) 108117739

(51) Int. Cl. G02B 27/58; G06T 3/40; H04N 9/04; H04N 7/18; H04N 5/225; B64G 1/10

(52) U.S. Cl. CPC G02B 27/58; G06T 3/4069; H04N 9/04555; B64G 2001/1028; H04N 5/2254; B64G 1/1021; H04N 7/185

(57) ABSTRACT

A Focal Plane Assembly (FPA) of a remote sensing satellite for receiving a focal plane image provided by an optical lens, comprises a sub-pixel shifting field separator, a first linear image sensor, and a second linear image sensor. The field separator split the focal plane image up into a first half focal plane image and a second half focal plane image, the first linear image sensor, located at an edge of a half focal plane, receives the first half focal plane image to generate a first image, the second linear image sensor, located at an edge of another half focal plane, receives the second half focal plane image to generate a second image, wherein a sub-pixel shifting relation is between the first image and the second image.

### BACKGROUND OF THE INVENTION

### 1. Field of the Invention

The present invention relates to a Focal Plane Assembly (FPA), and more particularly to a focal plane assembly and an image processing method thereof in a remote sensing satellite.

### 2. Description of Related Art

In an optical remote sensing satellite, an optical system design greatly decides the weight and the image capture ability for the entire satellite. In other words, directly decide the launch cost and performance of the satellite.

The Focal Plane Assembly (FPA) is the main component in the optical system, and mainly formed by CMOS sensing element, multi-spectrum band pass filter and a mechanism. The detail description can refer to Republic of China patent application number: 103117407, “CMOS image sensing device and manufacturing method thereof” or application number: 103117403, “large-scaled CMOS image sensing device and manufacturing method thereof”.

### SUMMARY OF THE INVENTION

The present invention provides a focal plane assembly. Without increasing too much cost, the present invention can improve the optical sensing ability of the remote sensing satellite and greatly improve the resolution of an optical image.

The present invention also provides an image processing method corresponding to the above focal plane assembly. In the FPA, two sensors are disposed, the two sensors respectively synchronously receive two half focal plane images existing a misplacement (sub-pixel shifting) and corresponding to a same focal plane. Then, using the two half focal plane images to perform a super-resolution interpolation operation using the two half focal plane images to generate a reconstructed image having higher resolution.

According to the present invention, a focal plane assembly for receiving a focal plane image provided by an optical lens, comprising: a field separator splitting the focal plane image into a first half focal plane image and a second half focal plane image; a first linear image sensor located at one side of the field separator to receive the first half focal plane image in order to generate a first image; and a second linear image sensor located at the other side of the field separator to receive the second half focal plane image in order to generate a second image; wherein a sub-pixel shifting is between the first image and the second image.

According to the present invention, an image processing method for receiving a first image and a second image from a focal plane assembly at a remote sensing satellite, wherein the focal plane assembly includes a field separator for splitting a focal plane image provided by into a first half focal plane image and a second half focal plane image, the first half focal plane image and the second half focal plane image are respectively received by a first linear sensor and a second linear sensor to generate the first image and the second image respectively, a sub-pixel shifting relation is between the first image and the second image, and the image processing method comprises steps of: receiving the first image; receiving the second image; and generating a reconstructed image by performing a super-resolution interpolation operation according to parameters corresponding to the sub-pixel shifting relation, the first image and the second image; wherein the first image and the second image are both corresponding to a same focal plane image.

### BRIEF DESCRIPTION OF THE DRAWINGS

FIG. 1 is a schematic diagram of a focal plane assembly according to an embodiment of the present invention;

FIG. 2 is a block diagram of an image processing system corresponding to the embodiment in FIG. 1; and

FIG. 3 is a flow chart of the image processing method according to an embodiment of the present invention.

### DETAILED DESCRIPTION OF THE PREFERRED EMBODIMENT

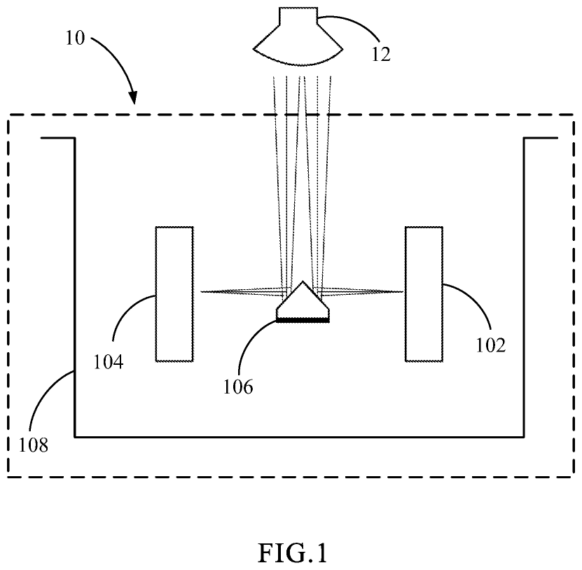

FIG. 1 is a schematic diagram of a focal plane assembly according to an embodiment of the present invention. A focal plane assembly 10 is disposed in an optical system. The focal plane assembly 10 includes sensors 102, 104 and a field separator 106. The focal plane assembly (FPA) 10 is received by a frame 108. Wherein, the sensors 102, 104 actually include a corresponding image processing circuit. In order to avoid the figures to be too messy, the present figure only shows the components which are directly related to the present invention, and omits the components which are not indirectly related to the present invention.

An optical lens 12 collects the lights of an observation point of the remote sensing satellite to generate a focal plane image and inputting to the focal plane assembly 10. The field separator 106 splits the focal plane image to generate a first half focal plane image at one side of the field separator 106 and generate a second half focal plane image at the other side of the field separator 106, and after respectively receiving and processing by the sensors 102 and 104 at corresponding directions, generating a first image and a second image. In one embodiment, the sensors 102 and 104 are realized by linear panchromatic sensors (PAN). Wherein, the first image and the second image have a sub-pixel shifting relation. In other words, the first image and the second image are both corresponding to a same focal plane image, but the first image and the second image are not totally the same image.

Through designing the locations of the sensors 102 and 104, between the first image and the second image, a fixed sub-pixel shifting relation is existed. Preferably, the sub-pixel shifting relation is 0.5 pixel. For example, placing the sensor 102 at an edge of the first half focal plane image, and placing the sensor 104 at an edge of the second half focal plane image, but shifting with 0.5 pixel such that a fixed 0.5 pixel offset relation(that is, the sub-pixel shifting) is existed between the first image and the second image.

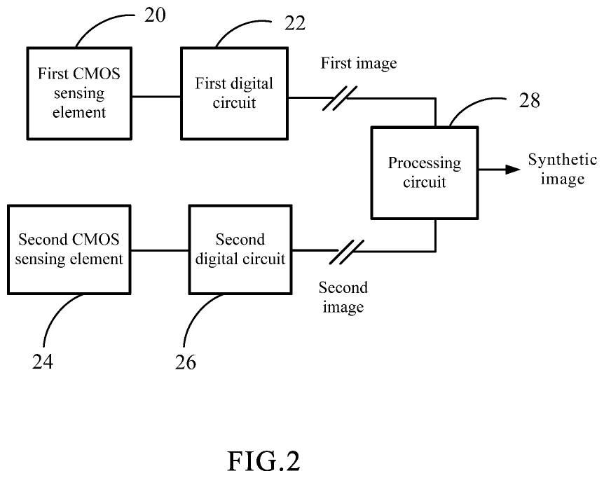

With reference to FIG. 2, FIG. 2 is a block diagram of an image processing system corresponding to the embodiment in FIG. 1. Wherein, a first CMOS sensing element 20 can correspond to the sensor 102, and the second CMOS sensing element 24 can correspond to the sensor 104. The first CMOS sensing element 20 receives the first half focal plane image located at the edge of the first half focal plane at one side of the field separator 106 to generate a first image after being processed by a first digital circuit 22. The second CMOS sensing element 24 receives the second half focal plane image located at the edge of the second half focal plane at the other side of the field separator 106 to generate a second image after being processed by a second digital circuit 26. Because the sub-pixel shifting relation between the first image and the second image has been decided, the processing circuit 28 obtains the offset relation such as field separator, 0.5 pixel or 0.8 pixel and corresponding parameters in advance. Performing a super-resolution interpolation operation using the first image and the second image and cooperating with various image processing technologies such as interpolation, de-convolution and noise filtering to process the image to become a reconstructed image having a higher resolution. The aforementioned image processing technologies are normal image processing methods known by the person in the present field, no more repeating. Wherein, the processing circuit 28 is generally placed on the ground to remotely receive the first image and the second image to perform related image processing.

The present invention and the Republic of China patent application number: 103117407, “CMOS image sensing device and manufacturing method thereof” both use the sub-pixel shifting to obtain two images having the offset relation and performing the interpolation operation. However, the two sensors in the prior art and the related circuits have to be disposed in a same wafer. Although the sub-pixel shifting relation between the two sensors can be accurately disposed in the prior patent application, the manufacturing complexity is extremely high, and the cost is also high. Comparing with that, the focal plane assembly of the present application can place the sensor 102 and the sensor 104 at different locations. In other words, the sensors 102 and 104 do not have to be manufactured in the same wafer, which have sufficient space to allocate the processing circuit required by them respectively so that the manufacturing difficult is greatly improved. Besides, because the sensors 102 and 104 in the present application is farther, the sub-pixel shifting relation between the two half focal plane images may not be accurate, which has a gap comparing to the expectation. However, the above difference can still be overcome by image processing operation software.

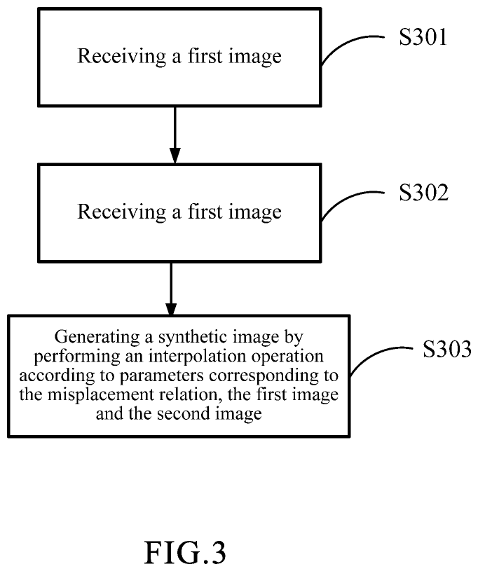

FIG. 3 is a flow chart of the image processing method according to an embodiment of the present invention. As described above, the aforementioned design can make the focal plane assembly of the remote sensing satellite to obtain two images corresponding to the same focal plane but having a fixed offset relationship. After the processing circuit 28 receives the first image and the second image at a step S301 and a step S302, the processing circuit 28 can perform an super-resolution interpolation operation cooperating with the data of the first image and the second image according to the parameters corresponding to the fixed offset relationship between the first image and the second image in a step S303 in order to generate the reconstructed image having a higher resolution.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

1. A focal plane assembly for receiving a focal plane image provided by an optical lens, comprising:
a field separator splitting the focal plane image into a first half focal plane image and a second half focal plane image;
a first linear image sensor located at one side of the field separator to receive the first half focal plane image in order to generate a first image; and
a second linear image sensor located at the other side of the field separator to receive the second half focal plane image in order to generate a second image;
wherein a fixed sub-pixel shifting is between the first image and the second image.

2. The focal plane assembly according to claim 1, wherein the first sensor and the second sensor are panchromatic sensors.

3. The focal plane assembly according to claim 1, wherein the first sensor and the second sensor are respectively located at an edge of the first half focal plane image and an edge of the second half focal plane image.

4. The focal plane assembly according to claim 1, wherein the fixed sub-pixel shifting relation between the first image and the second image is 0.5 pixel.

5. An image processing method for receiving a first image and a second image from a focal plane assembly at a remote sensing satellite, wherein the focal plane assembly includes a field separator for splitting a focal plane image provided by into a first half focal plane image and a second half focal plane image, the first half focal plane image and the second half focal plane image are respectively received by a first linear sensor and a second linear sensor to generate the first image and the second image respectively, a fixed sub-pixel shifting relation is between the first image and the second image, and the image processing method comprises steps of:
receiving the first image;
receiving the second image; and
generating a reconstructed image by performing a super-resolution interpolation operation according to parameters corresponding to the fixed sub-pixel shifting relation, the first image and the second image;
wherein the first image and the second image are both corresponding to a same focal plane image, but the first image and the second image are not totally the same.

6. The image processing method according to claim 5, wherein the fixed sub-pixel shifting relation is 0.5 pixel.
